(19) United States
(12) Patent Application Publication
(10) Pub. No.: US 2007/0195263 A1
(43) Pub. Date: Aug. 23, 2007

(54) METHOD OF MANUFACTURING MULTIFOCAL LENS AND MULTIFOCAL LENS

(75) Inventors: Akihiro SHIMIZU, Minowa-machi (JP); Kota NISHI, Minowa-machi (JP); Yoshitaka Goto, Tokyo (JP); Takanori MIYAZAWA, Tatsuno-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/677,246

(22) Filed: Feb. 21, 2007

(30) Foreign Application Priority Data
Feb. 22, 2006 (JP) 2006-045787
Jan. 12, 2007 (JP) 2007-005024

(51) Int. Cl. G02C 7/06

(52) U.S. Cl. 351/168

(57) ABSTRACT

A multifocal lens includes a group including M layered lenses. M-kinds (M is an integer of two or more) of lens materials having glass deformation point temperatures of At₁, At₂, . . . , At_{M}, are used and diluted by a heat press method. A contact surface of an N−1th lens (N is an arbitrary integer of two or more and M or less) contacted with an Nth lens is a concave face, a contact surface of the Nth lens contacted with the N−1th lens is a convex face. The glass deformation point temperatures have a relation of At_{N-1}>At_{N}.

### BACKGROUND OF THE INVENTION

1. Technical Field

The present invention relates to a multifocal lens and a method of manufacturing it.

2. Related Art

Conventionally, lenses as an optical component have been widely used for glasses and cameras for example. A lens is classified to a fixed length focal lens having only one focal point and a multifocal lens having a plurality of focal points.

Various multifocal lenses have been suggested such as a lens A as shown in FIG. 35(A) in which an optical surface partially includes a region having a different curvature, a lens B as shown in FIG. 35(B) in which an optical surface is partially attached with another lens by adhesive agent, or a lens C as shown in FIG. 35(C) in which peripheral parts and the center part of the lens bonded to one another are made of different materials (see JP-A-H11-023809 for example).

On the other hand, a method of manufacturing a layered fixed length focal lens has been suggested in which a previously heat-pressed convex face of the first lens is used as a part of a molding die to heat-press the second lens (see JP-A-2002-131511 for example).

JP-A-H11-023809 is a first example of related art (FIG. 1, FIG. 5, FIG. 6).

JP-A-2002-131511 is a second example of related art.

However, in the case of the lenses A and B shown in FIGS. 35(A) and 35(B), it is very difficult to polish optical surfaces A1 and B1 since they include faces A2 and B2 having different curvatures. Furthermore, in the case of the lens B shown in FIG. 35(B), it is also very difficult to align optical axes of two kinds of lenses since adhesive agent bonds them. In the case of the lens C shown in FIG. 35(C), a structure composed of peripheral parts C1 and a center part C2 requires a complicated process, causing a very high manufacture cost.

Furthermore, in designing these multifocal lenses, realizing a multifocal design is a key concern, but deteriorating optical characteristics of lens (various aberrations such as spheric aberration, transmission wavefront aberration, or chroma aberration). In case of a fix focal length lens, some optical systems are designed in order to improve the optical performance of the lens, for example, in which a lens face is changed from a spherical surface to an aspheric surface or a plurality of lenses are laminated instead of one lens. In order to improve chroma aberration in particular, two lenses having different optical characteristics called as achromatizing lenses (acromatic lenses) are laminated with adhesive agent. On the other hand, in case of a multifocal lens, using an aspheric surface or adhering a plurality of lenses also improve their optical performance similar to fix focal length lenses. Designing a multifocal lens, however, requires a complicated lens face, bringing a very difficult operation for bonding multi-layered lenses together.

JP-A-2002-131511 discloses a method of manufacturing a multi layered fix focal length lenses with heat-pressing in which a contact surface of a first lens that is firstly heat-pressed is formed to have a convex face. Then, a second lens material which is firstly processed (pre-formed) in accordance with the shape of the convex face must be prepared. However, a method of manufacturing a multi layered lens without the above first processing has been required for lowering a manufacturing cost, applying it to form a complicated lens face, and attaining a stable quality. In the case of a multifocal lens, the above problem has been more serious because of its more complicated design of a lens face.

### SUMMARY

In view of the above, the advantage of the invention is to provide a multifocal lens that has a superior optical characteristic and a method of manufacturing it easily.

According to a first aspect of the invention, a multifocal lens includes a group including M layered lenses. M-kinds (M is an integer of two or more) of lens materials having glass deformation point temperatures of At₁, At₂, . . . , At_{M}, are used and diluted by a heat press method. Further, a contact surface of an N−1th lens (N is an arbitrary integer of two or more and M or less) contacted with an Nth lens is a concave face, a contact surface of the Nth lens contacted with the N−1th lens is a convex face. The glass deformation point temperatures have a relation of At_{N-1}>At_{N}.

According to the first aspect, the glass deformation point temperature At_{N-1} of the N−1th lens is higher than the glass deformation point temperature At_{N} of the Nth lens. Thus, when the Nth lens is heat-pressed, the contact surface of the N−1th lens can be used as a part of a molding die. When the contact surface of the N−1th lens is a concave face, compression stress is applied to the Nth lens material having a fluid state thermally diluted in the vicinity of the contact surface of the N−1th lens. When the contact surface of the N−1th lens has a convex face on the contrary, tensile stress is applied to the surface of the Nth lens material having a fluid state thermally diluted in the vicinity of the contact surface of the N−1th lens. In the multifocal lens of the aspect, compression stress is applied to the center direction of the convex face of the Nth lens material. Thus, when compared with a case where tensile stress is applied, contact of an interface between the Nth lens and the N−1th lens is less influenced. This can provide a superior optical characteristic and can reduce damages in the interface such as crack and peeling.

By providing the above-described shape to the multifocal lens, the Nth lens can be bonded to the N−1th lens without a pre-form processing. Namely, a rice grain-like gob material having an almost convex surface shape is bonded to the concave face of the contact surface the N−1th lens before heat pressing. Thus, the multifocal lens of the aspect can provide a stable optical characteristic and a contact causing less crack or peeling and can provide a heat-pressed multifocal lens with a lower manufacture cost, while related art has required a gob material which needs a pre-form processing as a first processing (e.g., heat press processing, grinding processing).

According to a second aspect of the invention, a method of manufacturing a multifocal lens includes: a) forming a first lens by diluting a first lens material having a glass deformation point temperature At₁; b) forming a second lens by diluting a second lens material having a glass deformation point temperature At₂ (At₁>At₂) while using the first lens as a part of a molding die, and c) bonding the second lens to the first lens simultaneously with step b) so that a contact surface of the first lens contacting with the second lens is a concave face and a contact surface of the second lens contacting with first lens is a convex face.

According to the second aspect, the first lens can be used as a part of a molding die without being removed from the molding die and the second lens material is placed on the concave section of the first lens and is diluted. This can provide an accurate positioning of the first lens and the second lens. The accurate positioning can manufacture the multifocal lens easily.

The positioning by the above manufacture method is not limitedly applied to a multifocal lens and also may be applied to a fixed focal lens.

According to a third aspect of the invention, a method of manufacturing a multifocal lens includes: a) forming a first lens by diluting a first lens material having the glass deformation point temperature At₁ with heat pressing; b) forming a second lens by diluting a second lens material having a glass deformation point temperature At₂ (At₁>At₂) with heat pressing while using the first lens as a part of a molding die; c) bonding the second lens to the first lens simultaneously with step b); d) forming a third lens by diluting a third lens material having a glass deformation point temperature At₃ (At₁>At₂>At₃) with heat pressing while using the first lens and/or the second lens as a part of a molding die; and e) bonding the third lens to the first lens and/or the second lens simultaneously with step d).

The term “glass deformation point temperature (At)” means a temperature at which heated glass stops the thermal expansion and starts contracting and is higher than the glass transition temperature (Tg). When a glass product such as a lens is diluted out of lens material (glass material), the lens material is generally diluted by the heat press method at a temperature close to this glass deformation point temperature.

According to the third aspect, the three kinds of lens materials (glass materials) for which the glass deformation point temperatures have a relation of At₁>At₂>At₃ and one of the lens materials having a higher glass deformation point is firstly diluted so that the formed lens itself is used as a part of a molding die. The above process is repeated. This process eliminates a need for using adhesive agent for the contact of lens materials. Thus, a multifocal lens in which the respective lens materials are securely bonded can be manufactured easily thereby. The non-use of adhesive agent also can provide a favorable optical characteristic.

In the third aspect, it is preferable that the method include: f) forming one or more concave sections at an upper surface of the first lens; and g) placing the second lens material on the concave sections.

According to this method, an upper part of the formed first lens includes a concave section. Thus, the second lens can be stably placed on the first lens without being influence by the shape. Furthermore, the second lens as an intermediate lens can be arbitrarily set to have a desired size and layout. Thus, a multifocal lens which had been difficult to be manufactured can be easily designed and manufactured with a high quality by the method.

In the third aspect, it is preferable that the above method include: forming an upper surface of the first lens other than the concave sections as a concave face; forming an upper surface of the second lens to be a curved surface continuous from the concave faces of the first lens; and placing the third lens material on an upper surface of the continuous curved surface composed of the concave faces of the first lens and the upper part of the second lens.

According to the method, the upper surface formed by the continuous curved surface of the first lens and the second lens faces upward. Thus, the third lens material can be stably placed on this curved surface. Thus, the third lens can be easily and securely formed by the heat press method to have a predetermined shape without being influenced by the shape of the third lens material.

In the press formation as described above, the three kinds of lens materials are diluted so that the first lens and the third lens have substantially the same diameter and the second lens has a diameter smaller than the above diameter and the first lens and the third lens have an identical optical axis for example. This can provide a multifocal lens having a combination of lenses having three different characteristics and having a superior optical performance in an easy manner. In the method, the first lens, the second lens, and the third lens also may have an identical optical axis.

In the third aspect, it is preferable that step d) further include: d′) forming a reference surface having at least two different diameters so that an outer periphery of the multifocal lens is positioned at a portion having a stepped shape in which the lens is-attached; d″) making a diameter of the second lens smaller than a diameter of the first lens and a diameter of the third lens; and d′″) adjusting the optical axis of the third lens to be the same of the optical axis of the first lens.

According to the method, the reference surface formed at the outer periphery of the multifocal lens allows a multifocal lens to be positioned at the lens to-be-attached portion having a stepped shape. Thus, the multifocal lens can be accurately placed on the lens to-be-attached portion. This can reduce an inclination or an eccentric core of the multifocal lens.

in the second aspect, it is preferable that the method include: the three kinds of lens materials are diluted so that the first lens and the third lens have substantially the same diameter and the second lens has a doughnut-like shape and a diameter smaller than the diameter of the first lens and the third lens; and the first lens, the second lens and the third lens are adjusted to have the same optical axis

In the third aspect, it is preferable that a glass transition temperature of the first lens material be Tg₁, a glass transition temperature of the second lens material be Tg₂, and a glass transition temperature of the third lens material be Tg₃; the respective glass transition temperatures have a relation of Tg₁>Tg₂>Tg₃; and the respective glass transition temperatures have a relation of Tg₁>At₂ and a relation of Tg₂>At₃.

According to the method, the three kinds of lens materials have the glass transition temperatures for which the relation of Tg₁>Tg₂>Tg₃ is established and the relation of Tg₁>At₂ and the relation of Tg₂>At₃ are established. Thus, when the second lens material is diluted by the heat press method and is bonded to the first lens or when the first lens and the second lens are bonded with the third lens material is diluted by the heat press method, the lenses can be bonded easily without adhesive agent and without causing the deformation of the first lens or the second lens as a molding die.

In the second aspect, it is preferable that, in step a), the first lens material having the glass deformation point temperature At₁ is diluted to provide a concave section of a upper surface at which the first lens is contacted with the second lens and an uneven section for a positioning at a concentric circle of the concave section; and, in step b), the second lens material having the glass deformation point temperature At₂ is placed on the concave section surrounded by the uneven section.

According to the method, the uneven section for a positioning purpose provided on the concentric circle of the concave section of the contact surface of the first lens allows the second lens material to be positioned to the first lens so that the second lens can be accurately positioned to the first lens.

In the second aspect, it is preferable that the method include: forming a cutoff reference surface so that an outer periphery of the multifocal lens is positioned at the lens to-be-attached portion.

According to the method, the reference surface provided at the outer periphery of the multifocal lens allows the multifocal lens to be positioned at the lens to-be-attached portion having a stepped shape. Thus, the multifocal lens can be accurately provided at the lens to-be-attached portion. This can reduce an inclination or an eccentric core of the multifocal lens.

According to yet another aspect of the invention, the multifocal lens of the invention is manufactured by the above-described manufacture method.

Thus, the multifocal lens of the invention can have a structure in which the respective lenses materials have predetermined shapes and are securely bonded with a predetermined layout. This can provide favorable optical characteristics (e.g., various aberrations such as spheric aberration, transmission wavefront aberration, or chroma aberration).

In this respect, it is preferable that at least one type of lens material among the M-type lens materials is synthetic resin and at least one another type of lens material is glass.

According to the method, lens made of glass is bonded with as formed synthetic resin having a higher formability than that of glass to provide a multifocal lens composed of glass and synthetic resin. This can provide a multifocal lens for which a refractive index can be selected in a narrower range and a smaller thermal expansion coefficient is obtained, and a superior weather resistance of glass is maintained. Further, a shape of the lens, which is difficult to be formed if it is made of only a glass, is obtained due to easy molding of synthetic resin.

### BRIEF DESCRIPTION OF THE DRAWINGS

The invention will be described with reference to the accompanying drawings, wherein like numbers reference like elements.

FIG. 1 illustrates the structure of a multifocal lens according to Embodiment 1 of the invention.

FIG. 2 illustrates a step of forming the first lens (step of placing the first lens material) in Embodiment 1.

FIG. 3 illustrates a step of forming the first lens (heat pressing) in Embodiment 1.

FIG. 4 illustrates a step of forming the second lens (step of placing the second lens material) in Embodiment 1.

FIG. 5 illustrates a step of forming the second lens (heat pressing) in Embodiment 1.

FIG. 6 illustrates a step of forming the third lens (step of placing the third lens material) in Embodiment 1.

FIG. 7 illustrates a step of forming the third lens (heat pressing) in Embodiment 1.

FIG. 8 illustrates the structure of a multifocal lens in Embodiment 2 of the invention.

FIG. 9 illustrates a step of forming the second lens (step of placing the second lens material) in Embodiment 2.

FIG. 10(A) illustrates the structure of a multifocal lens in Embodiment 3 of the invention.

FIG. 10(B) illustrates the structure of a multifocal lens in Embodiment 3 of the invention.

FIG. 11(A) illustrates a step of forming the second lens (step of placing the second lens material) in Embodiment 3.

FIG. 11(B) illustrates a step of forming the second lens (step of placing the second lens material) in Embodiment 3.

FIG. 12 is a schematic cross-sectional view illustrating the structure of a multifocal lens according to Embodiment 4 of the invention.

FIG. 13 is a schematic cross-sectional view illustrating lens material placed on a formation surface of a lower metal mold.

FIG. 14 is a schematic cross-sectional view illustrating lens material pressed between a lower metal mold and an upper metal mold.

FIG. 15 is a schematic cross-sectional view illustrating the second lens material placed on the first lens.

FIG. 16 is a schematic cross-sectional view illustrating the second lens material pressed between a lower metal mold and an upper metal mold.

FIG. 17 is a schematic cross-sectional view illustrating a multifocal lens taken out of a metal mold.

FIG. 18(A) is a schematic cross-sectional view illustrating a multifocal lens according to Embodiment 5 of the invention.

FIG. 18(B) is a top view of the multifocal lens according to Embodiment 5 of the invention.

FIG. 19 is a schematic cross-sectional view illustrating lens material placed on a formation surface of a lower metal mold.

FIG. 20 is a schematic cross-sectional view illustrating lens material pressed between a lower metal mold and an upper metal mold.

FIG. 21 is a schematic cross-sectional view illustrating the second lens material placed on the first lens.

FIG. 22 is a schematic cross-sectional view illustrating the second lens material pressed between a lower metal mold and an upper metal mold.

FIG. 23 is a schematic cross-sectional view illustrating a multifocal lens according to Embodiment 6 of the invention.

FIG. 24(A) is a schematic cross-sectional view illustrating a multifocal lens according to Embodiment 7 of the invention.

FIG. 24(B) is a top view illustrating the multifocal lens according to Embodiment 7 of the invention.

FIG. 25 is a schematic cross-sectional view illustrating the second lens material placed on the first lens.

FIG. 26 is a schematic cross-sectional view illustrating a multifocal lens according to Embodiment 8 of the invention.

FIG. 27(A) is a schematic cross-sectional view illustrating lens material placed on a formation surface of a lower metal mold.

FIG. 27(B) is an expanded cross-sectional view of an upper metal mold.

FIG. 28(A) is a schematic cross-sectional view illustrating the first lens pressed between a lower metal mold and an upper metal mold.

FIG. 28(B) is an expanded cross-sectional view of the first lens of FIG. 28(A).

FIG. 29(A) is a schematic cross-sectional view illustrating when an upper metal mold is removed after the formation of the first lens.

FIG. 29(B) is a schematic top view of FIG. 29(A).

FIG. 29(C) is a partial expanded cross-sectional view of the first lens shown in FIG. 29(A).

FIG. 30 is a schematic cross-sectional view illustrating a multifocal lens according to Embodiment 9 of the invention.

FIG. 31 is a schematic cross-sectional view illustrating a step of forming the first lens.

FIG. 32 is a schematic cross-sectional view illustrating modification of Embodiment 9.

FIG. 33(A) is schematic cross-sectional view illustrating a modification of Embodiment 9.

FIG. 33(B) is the top view of the modification of Embodiment 9.

FIG. 34 is a schematic cross-sectional view illustrating a multifocal lens according to Embodiment 9 of the invention.

FIG. 35 illustrates the structure of a conventional multifocal lens.

### DESCRIPTION OF EXEMPLARY EMBODIMENTS

An embodiment of the invention will now be described with reference to the drawings. In the following description of the respective embodiments, members denoted with the same reference numerals will not be repeated or will be described briefly.

### Embodiment 1

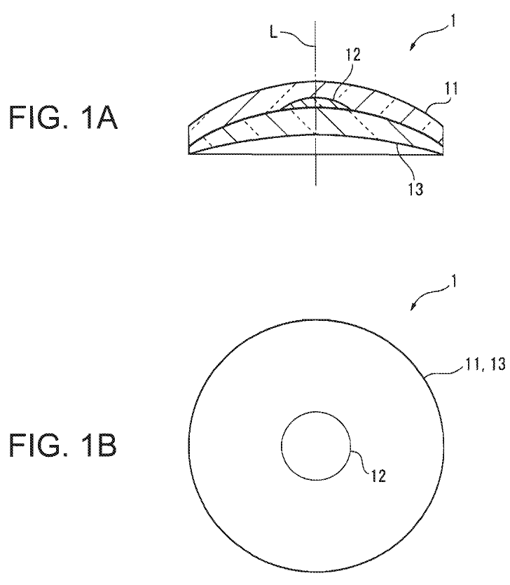

FIG. 1 to FIG. 7 show Embodiment 1 of the invention. Embodiment 1 is a multifocal lens 1 having a structure in which one group includes three layers.

FIG. 1 shows the multifocal lens 1 of Embodiment 1. This multifocal lens 1 is structured, as show n in the cross-sectional view of FIG. 1(A), a to have a layered structure including from the convex face side, the first lens 11 having a glass deformation point temperature At₁ (hereinafter may be simply referred to as “lens 11”), the second lens 12 having a glass deformation point temperature At₂ (hereinafter may be simply referred to as “lens 12”), and the third lens 13 having a glass deformation point temperature At₃ (hereinafter may be simply referred to as “lens 13”). Here, the above-described glass deformation point temperatures At₁, At₂, and At₃ have a relation of At₁>At₂>At₃. The respective lenses have glass transition temperatures for which a relation of Tg₁>Tg₂>Tg₃ is established and relations of Tg₁>At₂ and Tg₂>At₃ are established.

As is clear from the top view of FIG. 1(B), the lens 11 and the lens 13 have the same outer diameter that is larger than an outer diameter of the lens 12. These three lenses 11, 12, and 13 have the same optical axis L.

Here, Table 1 shows a basic specification of lens materials (glass materials) forming the respective lenses 11, 12, and 13 used in Embodiment 1. Any of the materials is made by OHARA INC. and has an optical lens grade.

TABLE 1

| | Glass material | Refractive | Abbe number | | |
|---|---|---|---|---|---|
| Lens | name | index nd | vd | Tg | At |
| 11 | S-LAH79 | 2.00330 | 28.3 | 699 | 731 |
| | | | | degrees | degrees |
| 12 | S-TIH1 | 1.71736 | 29.5 | 622 | 653 |
| | | | | degrees | degrees |
| 13 | L-BAL35 | 1.58913 | 61.2 | 527 | 567 |
| | | | | degrees | degrees |

A method for manufacturing the multifocal lens 1 as described above will be described.

(Step of Forming Lens 11)

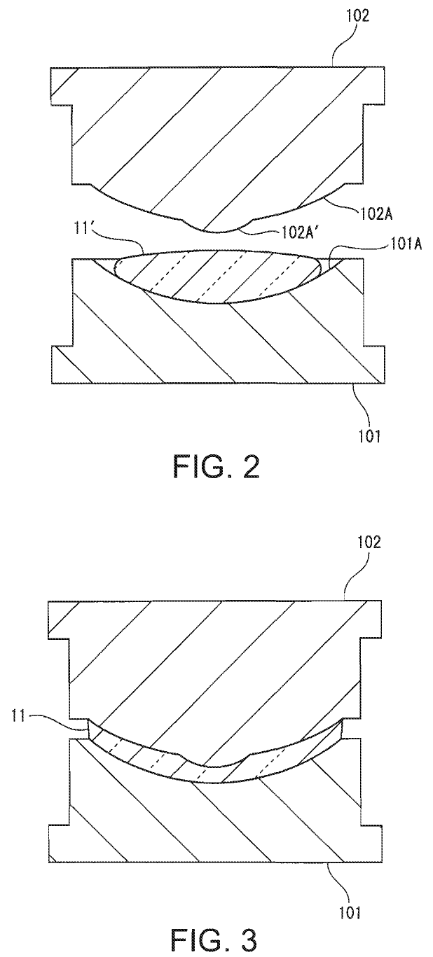

FIG. 2 is a schematic cross-sectional view illustrating a lens material 11′ having the highest glass deformation point temperature and the highest glass transition temperature placed on a formation surface 101A of a lower metal mold 101.

The lens material 11′ is provided in advance as pre-form glass material having the same volume as the design volume of the lens 11. The lens material 11′ has a spherical shape, a spheroidal shape, or a meniscus shape close to the shape of a formed lens.

An upper metal mold 102 has a formation surface 102A having a downwardly-convex shape that has the substantial center part having a convex section 102A′ having a further downwardly-convex shape. This convex section 102A′ functions to form a concave section bonded with the lens 12 (which will be described later) at the upper surface of the lens 11.

As shown in FIG. 3, the lens material 11′ is placed on the formation surface 101A of the lower metal mold 101 to subsequently heat the lower metal mold 101, the upper metal mold 102, and the lens material 11′ until a forming temperature Tp₁ is reached. Then, the lower metal mold 101 and the upper metal mold 102 are closed to form the lens 11. The forming temperature Tp₁ is higher than Tg₁ and is determined by appropriately selecting a temperature close to a deformation point temperature At₁. It is noted that FIG. 3 does not show a metal mold for forming a side surface of the lens 11. This not shown metal mold may be integrated with the upper metal mold 102.

(Step of Forming Lens 12)

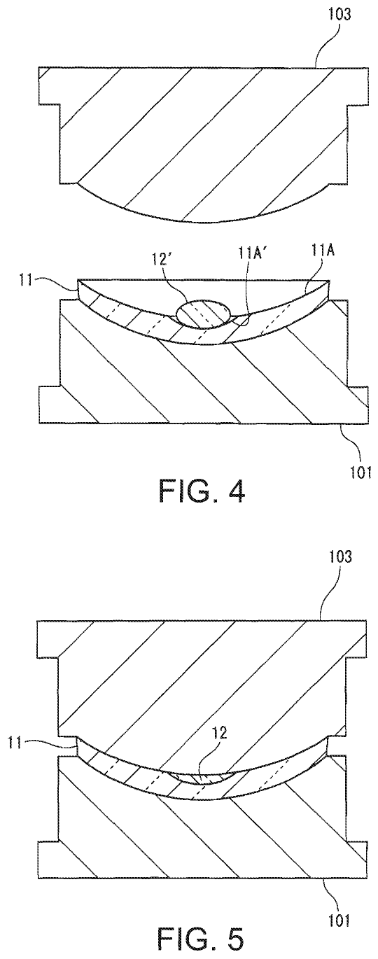

After the lens 11 is formed, the lower metal mold 101, the upper metal mold 102 and lens 11 are cooled to a temperature close to a room temperature to subsequently remove the upper metal mold 102 to newly place an upper metal mold 103 for forming the lens 12 (FIG. 4).

As shown in FIG. 4, the lens 11 has an upper surface including a concave face 11A that has, at the substantial center part thereof, a small concave section 11A′ formed by the convex section 102A′ of the above-described upper metal mold 102. This concave section 11A′ has a curvature radius smaller than that of the concave face 11A.

Next, a lens material 12′ is placed on an upper surface of this concave section 11A′. The lens material 12′ is manufactured in advance to have a pre-form shape having the same volume as the design volume of the lens 12. This pre-form shape is a spherical shape, a spheroidal shape, or a meniscus shape close to the shape of a formed lens for example. However, this pre-form shape in Embodiment 1 has a spheroidal shape that has a curvature radius smaller than a curvature radius of the concave face 11A formed at the substantial center of the upper part of the lens 11. The shape as described above can provide an easier positioning of the lens material 12′.

As shown in FIG. 5, the lens 12 is formed by the upper metal mold 103 at a forming temperature Tp₂. The forming temperature Tp₂ higher than Tg₂ and is determined by appropriately selecting a temperature close to a deformation point temperature At₂. It is noted that FIG. 5 does not show a metal mold for forming a side surface of the lens 11. This not shown metal mold may be integrated with the upper metal mold 103.

Then, the lens 12 and the lens 11 are fused by a glass-to-glass chemical reaction. The lens 11 (lens material 11′) has a glass deformation point temperature and a glass transition temperature higher than those of the lens 12 (lens material 12′) and has a relation of Tg₁>At₂. Thus, the lens 11 itself does not deform.

(Step of Forming Lens 13)

After the formation of the lens 12, the lower metal mold 101, the upper metal mold 103, and the lens 12 are cooled to a temperature close to a room temperature to subsequently remove the upper metal mold 103.

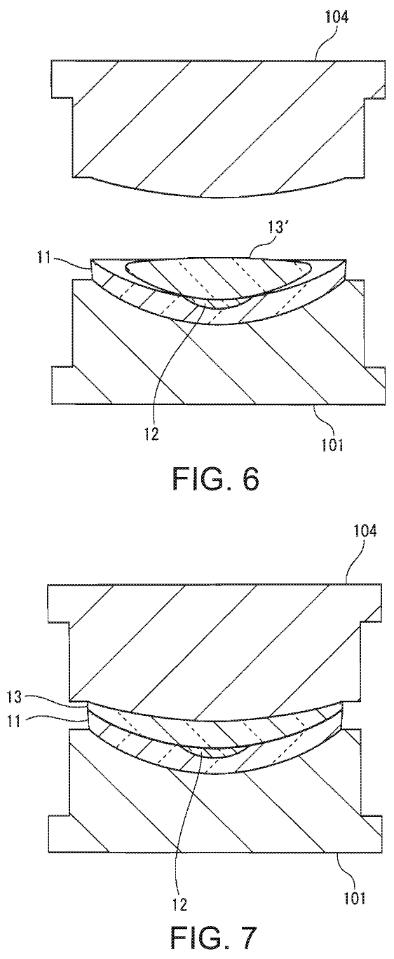

Next, as shown in FIG. 6, the lens material 13′ is placed on the upper surface (concave face) of the lenses 11 and 12. The lens material 13′ is manufactured in advance as pre-form glass material having the same volume as the design volume of the lens 13. This pre-form shape preferably has a spherical shape, a spheroidal shape, or a meniscus shape close to the shape of a formed lens for example. However, this pre-form shape in this embodiment has a spheroidal shape having a curvature radius smaller than the curvature radii of the upper surfaces (concave faces) of the lenses 11 and 12. The shape as described above provides an easier positioning of the lens material 13′.

Next, as shown in FIG. 7, the lens 13 is formed by an upper metal mold 104 at a forming temperature Tp₃. The forming temperature Tp₃ is higher than Tg₃ and is determined by appropriately selecting a temperature close to a deformation point temperature At₃. It is noted that FIG. 6 does not show a metal mold for forming a side surface of the lens 11. This not shown metal mold may be integrated with the upper metal mold 104.

Then, the lens 12 and the lens 11 are fused by a glass-to-glass chemical reaction. The lens 11 and the lens 12 have a glass deformation point temperature and a glass transition temperature higher than those of the lens 13 (lens material 13′) and have a relation of Tg₂>At₃. Thus, the lens 11 itself and the lens 12 itself do not deform.

Through the respective steps as described above, the multifocal lens 1 having the structure in which one group includes three layers is manufactured (FIG. 1). Embodiment 1 as described above can provide effects as shown below.

(1) The multifocal lens 1 of Embodiment 1 uses three kinds of lens materials having glass deformation point temperatures At₁, At₂, and At₃ and is a lens that is formed by the heat press method and that has a structure in which one group includes three layers. A contact surface of the first lens 11 to the second lens 12 is a concave face. A contact surface at which the second lens 12 is bonded to the first lens is composed of a convex face and the glass deformation point temperatures have a relation of At₁>At₂. A contact surface at which the second lens 12 is bonded to the third lens 13 also has a concave face. A contact, surface at which the third lens 13 is bonded to the second lens 12 is composed of a convex face. The glass deformation point temperatures have a relation of At₂>At₃. Thus, the first lens 11 has the glass deformation point temperature At₁ higher than the glass deformation point temperature At₂ of the second lens 12. Thus, the contact surface of the first lens 11 can be used as a part of a molding die when the second lens 12 is heat-pressed. The second lens 12 also has the glass deformation point temperature At₂ higher than the glass deformation point temperature At₃ of the third lens 13. Thus, the contact surface of the second lens 12 can be used as a part of a molding die when the third lens 13 is heat-pressed. When the contact surface of the first lens 11 is a concave face, compression stress is applied to the surface of the second lens material 12′ having a fluid state thermally diluted in the vicinity of the contact surface of the first lens 11. When the contact surface of the first lens has a convex face on the contrary, tensile stress is applied to the surface of the second lens material 12′ having a fluid state thermally diluted in the vicinity of the contact surface of the first lens 11. In the multifocal lens 1, compression stress is applied in the center direction of the convex faces of the second lens material 12′ and the third lens material 13′. Thus, when compared with a case where tensile stress is applied, contact of an interface between the second lens and the first lens and an interface between the third lens and the second lens is less influenced. This can provide a superior optical characteristic and can reduce damages in the interface (e.g., crack, peeling).

By providing the above-described shape to the multifocal lens 1, the second lens material 12′ can be bonded to the first lens 11 without a pre-form processing by joining a rice grain-like gob material having an almost convex surface shape before heat pressing with the concave face of the contact surface of the first lens 11 adjacent to the gob material. The third lens material 13′ also can be bonded to the first lens 12 without a pre-form processing by joining a rice grain-like gob material having an almost convex surface shape before heat pressing with the concave face of the contact surface of the first lens 12 adjacent to the gob material. Thus, while related art has required a gob material to be subjected to a pre-form processing as a first processing (e.g., heat press processing, grinding processing) the multifocal lens 1 making by the above-described processing can provide a stable optical characteristic and contact causing less crack or peeling and can reduce the manufacture cost of a heat-pressed multifocal lens.

(2) The three kinds of lenses 11, 12, and 13 are physically and chemically bonded by the heat press method. Thus, the multifocal lens 1 having a structure in which one group includes three layers can be easily manufactured without using adhesive agent. The non-use of adhesive agent also can prevent the optical characteristic of the multifocal lens 1 from receiving an adverse affect.

(3) The three kinds of lens materials have glass deformation point temperatures for which a relation of At₁>At₂>At₃ is established. Furthermore, the respective lenses have glass transition temperatures for which a relation of Tg₁>Tg₂>Tg₃ is established and relations of Tg₁>At₂ and Tg₂>At₃ are established. Thus, when the lens material 12′ is diluted by the heat press method and is bonded to the lens 11 and when the lens material 13′ is diluted by the heat press method and is bonded to the lens 11 and the lens 12, these lenses can be easily bonded one another without causing deformation of the lens 11 and the lens 12 and without using adhesive agent. Specifically, the lens 11 itself or the lens 12 itself can be used as a stable molding die.

(4) At the substantial center of the upper surface of the lens 11, the concave section 11A′ is formed and the lens material 12′ is placed on the concave section 11A′. Thus, the placement can be done without being influenced by the shape of the lens material 12′. Thus, the lens 2 functioning as an intermediate lens can have an arbitrary size and position to manufacture multifocal lenses having various intermediate lens shapes in an easy and simple manner. Optical axes of the lens 11 and the lens 12 also can be aligned easily.

(5) The upper surface other than the concave section 11A′ of the lens 11 is formed to have a concave face and the upper surface of the lens 12 is formed so as to be a curved surface continuous from the concave face of the lens 11 so that the lens material 13′ is placed on the upper surface as a continuous surface diluted by the concave face of the lens 11 and the upper surface of the lens 12. Thus, the lens material 13′ can be stably placed without being influenced by the shape. Optical axes of the lens 13′ the lens 12, and the lens 13 also can be aligned easily. Therefore, the formed multifocal lens 1 is prevented from having an eccentric core and thus a favorable optical characteristic (e.g., transmission wavefront aberration characteristic) can be realized.

(6) The multifocal lens 1 having a structure in which one group includes three layers is structured so that the lens 12 as an intermediate lens is perfectly positioned at the interior thereof to prevent the multifocal lens 1 from having a change in the curvature of the outer surface. Thus, the multifocal lens 1 can be easily subjected to a polishing processing as required.

### Embodiment 2

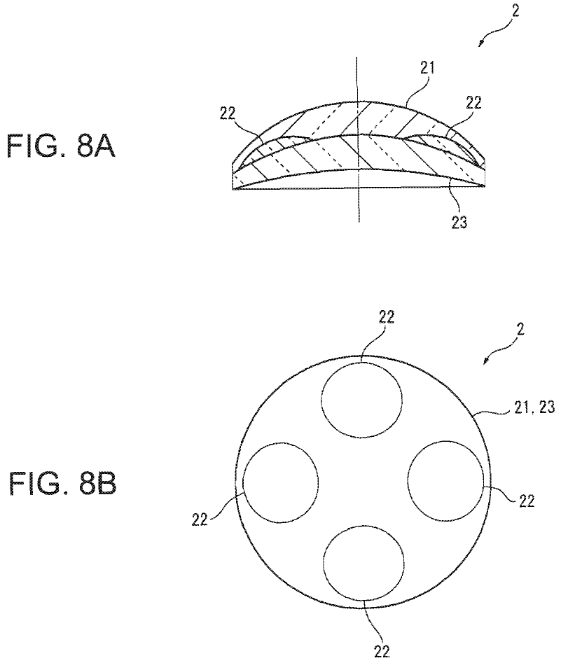

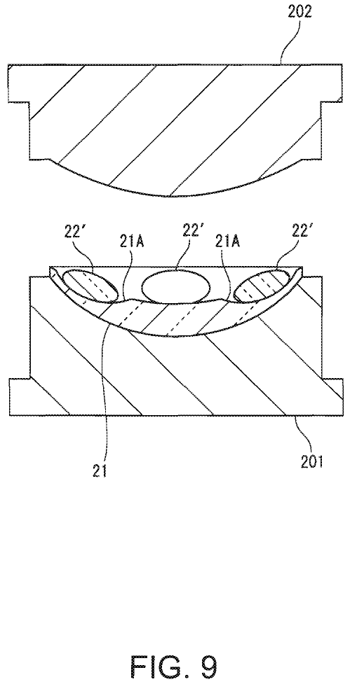

Next, Embodiment 2 of the invention will be described with reference to FIGS. 8(A) and 8(B) and FIG. 9. Embodiment 2 has the same structure as that of Embodiment 1 except for that the number and lay-out of lenses positioned at an intermediate position.

As shown in FIGS. 8(A) and 8(B), a multifocal lens 2 having a structure in which one group includes three layers of Embodiment 2 is composed of three layers of a lens 21, a lens 22, and a lens 23. The lens 22 positioned at an intermediate position is positioned so as to be dislocated from the optical axes of the lenses 21 and 23. Although Embodiment 2 arranges the four lenses 22 on a concentric circle around the optical axis as shown in FIG. 8(B), the lenses 22 are not always required to be on the concentric circle and an arbitrary number of lenses 22 also can be arranged at arbitrary positions in accordance with the optical characteristic of the multifocal lens 2.

The multifocal lens 2 as described above also can be manufactured as in Embodiment 1.

Specifically, as shown in FIG. 9, the lens 21 having the highest, glass deformation point temperature and the highest glass transition temperature is firstly formed as in Embodiment 1. Then, a concave section 21A is formed in the lens 21 at a position at which the lens 22 is positioned and the posture of a metal mold is controlled so that the concave section 21A faces upward. Then, a lens material 22′ is placed on an upper surface of this concave section to subsequently form the lens 22 by an upper metal mold 202. The lens 23 is similarly formed. The other manufacture conditions are the same as those of Embodiment 1 as described above.

### Embodiment 3

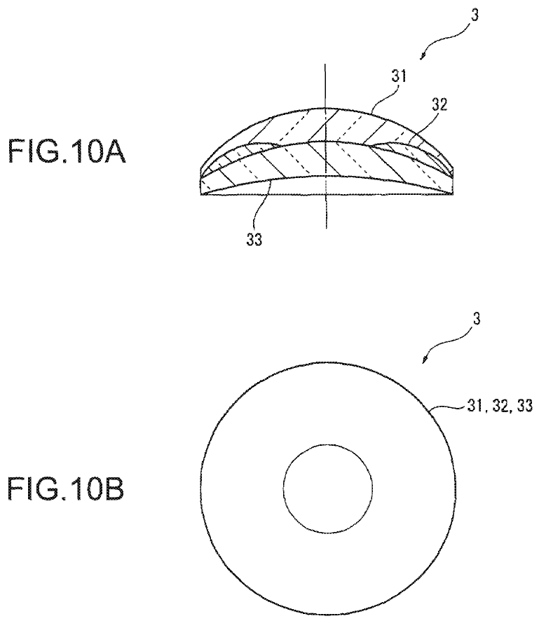

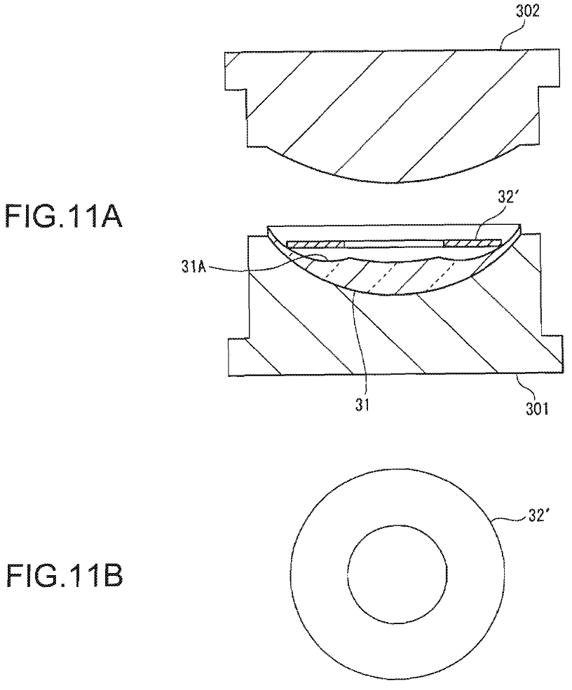

Next, Embodiment 3 of the invention will be described with reference to FIGS. 10(A) and 10(B) and FIGS. 11(A) and 11(B). Embodiment 3 has the same structure as that of Embodiment 1 except for the shape of the lens at the intermediate position.

In a multifocal lens 3 of Embodiment 3 shown in FIGS. 10(A) and 10(B), a lens 32 positioned at an intermediate position has a doughnut-like shape having no center part. The multifocal lens 3 as described above also can be manufactured by the above-described manufacture method.

Specifically, as shown in FIGS. 11(A) and 11(B), the first lens 31 having the highest glass deformation point temperature is firstly formed. The first lens 31 includes a concave section 31A at a position at which the second lens 32 is placed. The posture of a lower metal mold 301 is controlled so that this concave section 31A faces upward.

The second lens material 32′ is shaped to have a doughnut-like disk having no center part as shown in FIGS. 11(A) and 11(B). Thus, the second lens 32 having been heat-pressed by an upper metal mold 302 also has a doughnut-like shape.

The other manufacture conditions are the same as those of Embodiment 1 as described above. Finally, the multifocal lens 3 having the structure in which one group includes three layers shown in FIGS. 10(A) and 10(B) is obtained.

It is noted that, although the respective lenses of Embodiment 1 to Embodiment 3 have a circular shape, the lenses need not have a circular shape and a lens having a rectangular shape also can be used. One side or both sides of a multifocal lens also may be adhered with another lens as required. A multifocal lens has thereon an appropriate hard coat film or an antireflection film. The multifocal lens of the invention is particularly advantageous in the above-described adhesion step and film formation step because a curvature of an outer surface can be uniformly set.

The shapes of the first lens, the second lens, and the third lens are not limited to a spherical shape and also may easily have an aspheric shape by the same manufacture method.

### Embodiment 4

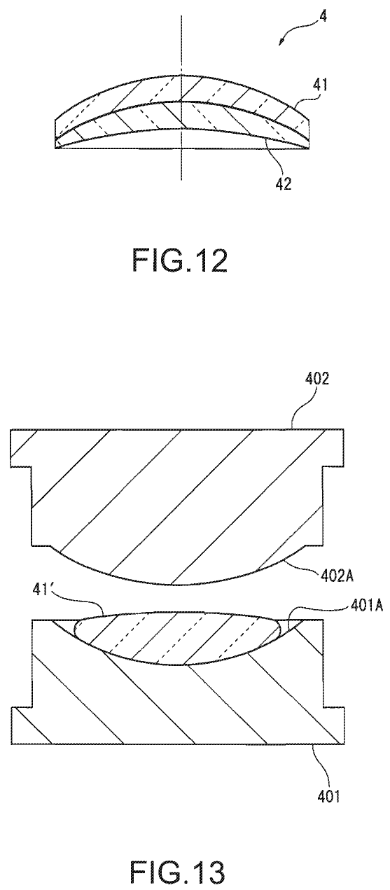

Next, Embodiment 4 of the invention will be described with reference to FIG. 12. Embodiment 4 has a lens structure in which one group includes two layers.

FIG. 12 is a schematic cross-sectional view illustrating the structure of a multifocal lens 4 having the structure of Embodiment 4 in which one group includes two layers.

As shown in FIG. 12, the multifocal lens 4 having the structure in which one group includes two layers is obtained by layering, from the convex face side, the first lens 41 (hereinafter may be simply referred to as “lens 41”) having a glass deformation point temperature At₁ and the second lens 42 (hereinafter may be simply referred to as “lens 42”) having a glass deformation point temperature At₂. The above glass deformation point temperatures At₁ and At₂ have a relation of At₁>At₂. The respective lenses have glass transition temperatures for which a relation of Tg₁>Tg₂ and a relation of Tg₁>At₂ are established.

As can be seen from FIG. 12, the lens 41 and the lens 42 have an identical outer diameter. These two lenses 41 and 42 have an identical optical axis L.

The respective lenses 41 and 42 used in Embodiment 4 may be made of various lens materials (glass materials). For example, the first lens 41 may have the same structure as that of the lens 11 of Embodiment 1 shown in Table 1 and the second lens 42 may have the same structure as that of the lens 13 shown in Table 1.

A method for manufacturing the multifocal lens 4 as described above will be described with reference to FIG. 13 to FIG. 17 (step of forming lens 41).

FIG. 13 is a schematic cross-sectional view illustrating lens material 41′ having a higher glass deformation point temperature and a higher glass transition temperature is placed on a formation surface 401A of a lower metal mold 401.

The lens material 41′ is manufactured in advance as pre-form glass material having the same volume as the design volume of the lens 41. The lens material 41′ may have a spherical shape, a spheroidal shape, or a meniscus shape close to the shape of a formed lens for example.

Here, an upper metal mold 402 has a formation surface 402A having a downwardly convex shape.

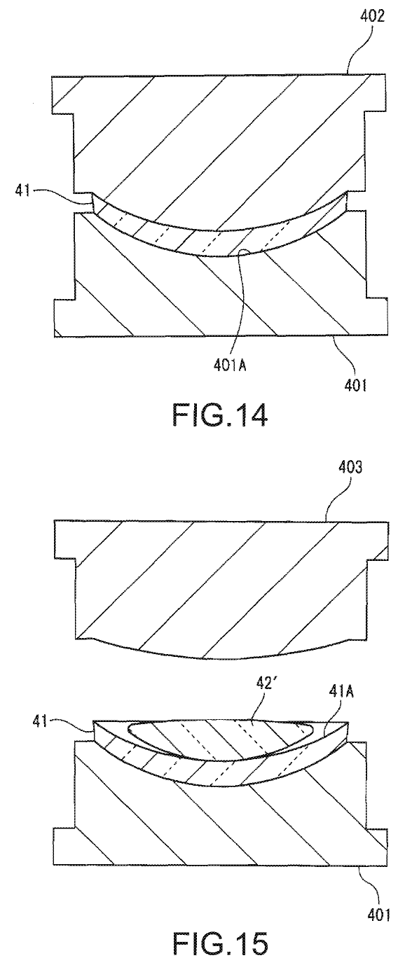

As shown in FIG. 14, the lens material 41′ is placed on the formation surface 401A of the lower metal mold 401 to heat a lower metal mold 401, an upper metal mold 402, and the lens material 41′ until a forming temperature Tp1 is reached. Then, the lower metal mold 401 and the upper metal mold 402 are closed to form the lens 41. The forming temperature is higher than Tp₁ and is determined by appropriately selecting a temperature close to a deformation point At₁. It is noted that FIG. 14 does not show a metal mold for forming a side surface of the lens 41. This not shown metal mold may be integrated with the upper metal mold 402.

(Step of Forming Lens 42)

After the formation of the lens 41, the lower metal mold 401, the upper metal mold 402, and the lens 41 are cooled to a temperature close to a room temperature. Then, the upper metal mold 402 is removed and an upper metal mold 403 for forming the lens 42 is newly placed (FIG. 15).

As shown in FIG. 15, the lens 41 includes a concave face 41A at the upper surface. Lens material 42′ is placed on the concave face 41A of the lens 41. The lens material 42′ is manufactured in advance as pre-form glass material having the same volume as the design volume of the lens 42. This pre-form shape preferably has a spherical shape, a spheroidal shape, or a meniscus shape close to the shape of a formed lens for example. However, this pre-form shape in this embodiment has a spheroidal shape having a curvature radius smaller than the curvature radius of the concave face 41A of the lens 41. The shape as described above provides an easier positioning of the lens material 42′.

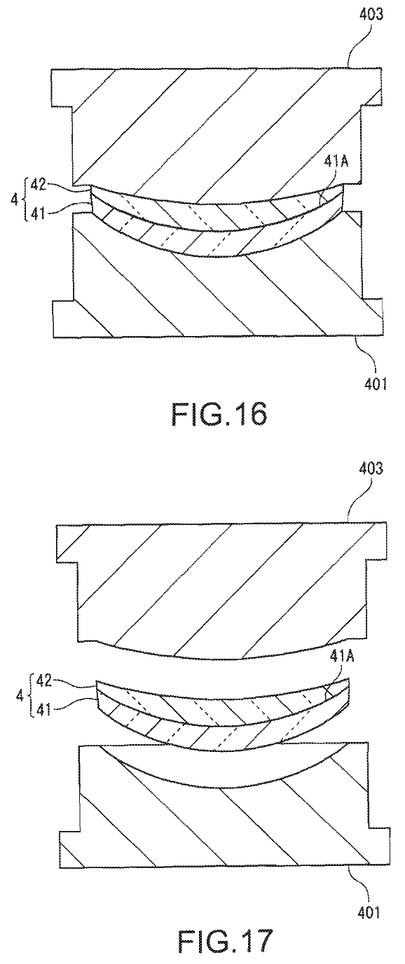

Next, as shown in FIG. 16, the lens 42 is formed by the upper metal mold 403 at the forming temperature Tg₂. The forming temperature Tp₂ is higher than Tg₂ and is determined by appropriately selecting a temperature close to a deformation point temperature At₂. It is noted that FIG. 16 does not show a metal mold for forming side surfaces of the lens 41 and the lens 42. This not shown metal mold may be integrated with the upper metal mold 403.

Then, the lens 41 and the lens 42 are fused by a glass-to-glass chemical reaction. The lens 41 itself does not deform because the lens 41 has a higher glass deformation point temperature and a higher glass transition temperature than those of the lens 42 and has a relation of Tg₁>At₂.

After the formation of the lens 42, the lower metal mold 401, the upper metal mold 403, and the lens 42 are cooled to a temperature close to a room temperature. Then, the upper metal mold 403 is removed. Thereafter, the multifocal lens 4 having the layered structure of the lens 41 and the lens 42 and having the structure in which one group includes two layers is taken out of the lower metal mold 401 (FIG. 17).

Through the respective steps as described above, the multifocal lens 4 shown in FIG. 12 having the structure in which one group includes two layers is manufactured. Embodiment 4 as described above can provide the effects as described below.

The multifocal lens 4 of Embodiment 4 uses two kinds of lens materials having the glass deformation point temperatures of At₁ and At₂ and has the structure in which one group includes two layers and that is formed by the heat press method. A contact surface at which the first lens 41 is contacted with the second lens 42 has a concave face. A contact surface at which the second lens 42 is contacted with the first lens 41 is composed of a convex face. The glass deformation point temperatures have a relation of At₁>At₂. Thus, the glass deformation point temperature At₁ of the first lens 41 higher than the glass deformation point temperature At₂ of the second lens 42 allows, when the second lens 42 is heat-pressed, the contact surface of the first lens 41 to be used as a part of a molding die. When the contact surface of the first lens 41 is a concave face, compression stress is applied to the surface of the second lens material 42 having a fluid state thermally diluted in the vicinity of the contact surface of the first lens. When the contact surface of the first lens has a convex face on the contrary, tensile stress is applied to the surface of the second lens material having a fluid state thermally diluted in the vicinity of the contact surface of the first lens. In the multifocal lens 4, compression stress is applied in the center direction of the convex face of the second lens material 42′. Thus, when compared with a case where tensile stress is applied, contact of an interface between the second lens and the first lens is less influenced. This can provide a superior optical characteristic and can reduce damages in the interface (e.g., crack, peeling).

By providing the above-described shape to the multifocal lens 4, the second lens material 42′ can be bonded to the first lens without a pre-form processing by joining a rice grain-like gob material having an almost convex surface shape before heat pressing with the concave face of the contact surface of the first lens adjacent to the gob material. Thus, while related art has required a gob material to be subjected to a pre-form processing as a first processing (e.g., heat press processing, grinding processing), the multifocal lens 4 having the above-described shape can provide a stable optical characteristic and contact causing less crack or peeling and can reduce the manufacture cost of a heat-pressed multifocal lens.

Furthermore, the first lens 41 is formed by diluting a first lens material having a glass deformation point temperature At₁. Then, the second lens 42 is formed by diluting a second lens material having a glass deformation point temperature At₂ (At₁>At₂) while the first lens is used as a part of a molding die. The second lens 42 is bonded to the first lens 41 simultaneously at the time of forming the second lens 42. A contact surface of the first lens 41 contacting with the second lens 42 is a concave face and a contact surface of the second lens 42 contacting with the first lens 41 is a convex face. Thus, by using the first lens 41 as a part of a molding die without being removed from the molding die, the second lens material is placed on the concave section of the first lens 41 and is diluted. This can provide an easy positioning of the first lens 41 and the second lens to manufacture the multifocal lens 4 in an easy manner.

The positioning by the manufacture method of the multifocal lens 4 of Embodiment 4 is not limitedly applied to a multifocal lens and also may be applied to a fixed focal lens.

### Embodiment 5

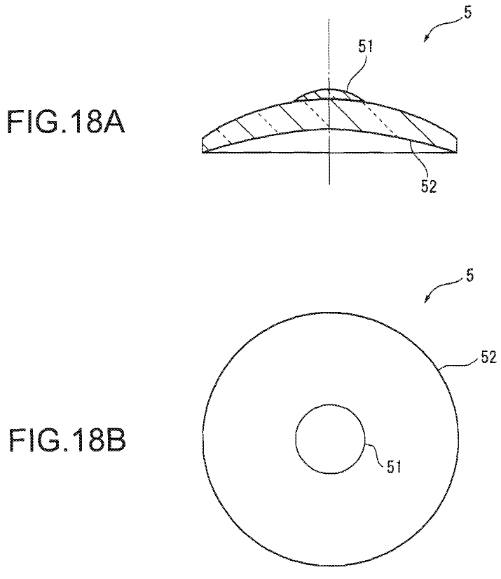

Next, Embodiment 5 of the invention will be described with reference to FIGS. 18(A) and 18(B) to FIG. 22. Embodiment 5 has the same structure as that of Embodiment 4 except for the shape of the first lens.

FIGS. 18(A) and 18(B) are a schematic cross-sectional view illustrating the structure of a multifocal lens 5 of Embodiment 5 having a structure in which one group includes two layers.

As shown in FIGS. 18(A) and 18(B), the multifocal lens 5 having the structure in which one group includes two layers is provided by layering, from the convex face side, the first lens 51 (hereinafter may be simply referred to as “lens 51”) having the glass deformation point temperature At₁ and the second lens 52 (hereinafter may be simply referred to as “lens 52”) having the glass deformation point temperature At₂. The above-described glass deformation point temperatures have a relation of At₁>At₂. Furthermore, the respective lenses have glass transition temperatures for which a relation of Tg₁>Tg₂ and a relation of Tg₁>At₂ are established.

As can be seen from FIGS. 18(A) and 18(B), the lens 51 has an outer diameter smaller than that of the lens 52. Furthermore, these two lenses 51 and 52 have an identical optical axis L.

Here, lens material (glass material) for forming the first lens 51 of Embodiment 5 is the same as that of the first lens 41 and lens material (glass material) for forming the second lens 52 is the same as that of the second lens 42 of Embodiment 4.

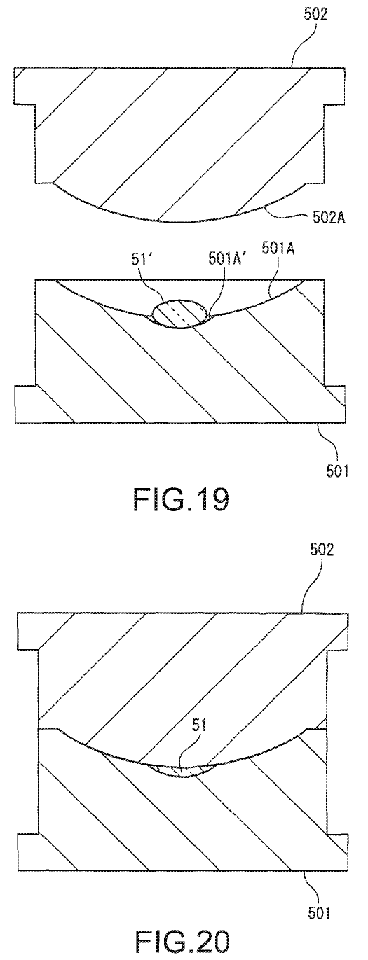

A method for manufacturing the multifocal lens 5 as described above will be described with reference to FIG. 19 to FIG. 22. (Step of forming lens 51)

FIG. 19 is a schematic cross-sectional view illustrating the lens material 51′ having a glass higher deformation point temperature and a higher glass transition temperature placed on a formation surface 501A of a lower metal mold 501.

The lens material 51′ is manufactured in advance as pre-form glass material having the same volume as the design volume of the lens 51. The lens material 51′ may have a spherical shape, a spheroidal shape, or a meniscus shape close to the shape of a formed lens for example.

Here, an upper metal mold 502 has a formation surface 502A having a downwardly convex shape. At the substantial center part of the formation surface 501A of the lower metal mold 501, the concave section 501A′ is formed at a further lower side.

As shown in FIG. 20, the lens material 51′ is placed on the formation surface 501A of the lower metal mold 501 to subsequently heat the lower metal mold 501, the upper metal mold 502, and the lens material 51′ until the forming temperature Tp1 is reached. Then, the lower metal mold 501 and the upper metal mold 502 are closed to form the lens 51. The forming temperature is higher than Tp1 and is determined by appropriately selecting a temperature close to the deformation point At₁.

(Step of Forming Lens 52)

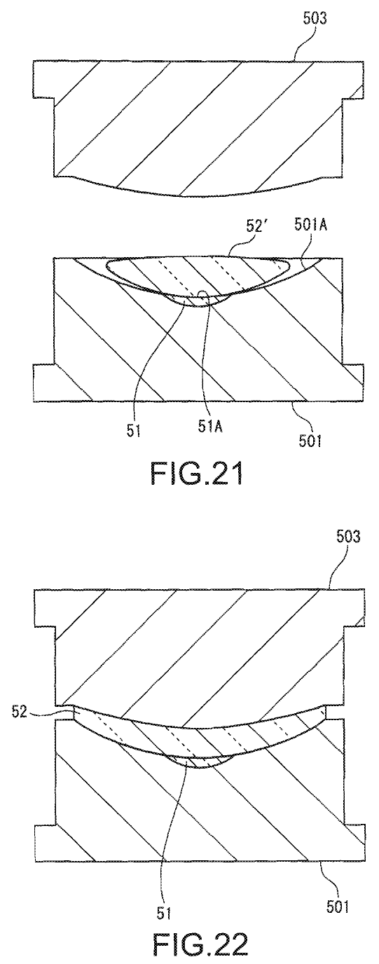

After the formation of the lens 51, the lower metal mold 501, the upper metal mold 502, and the lens 51 are cooled to a temperature close to a room temperature. Thereafter, the upper metal mold 502 is removed to newly place an upper metal mold 503 for forming the lens 52 (FIG. 21).

As shown in FIG. 21, the lens 51 is structured so that the upper surface includes a concave face 51A. Lens material 52′ is placed on the concave face 51A of the lens 51 or the concave face 51A of the lens 51 and the formation surface 501A of the lower metal mold 501. The lens material 52′ is manufactured in advance as pre-form glass material having the same volume as the design volume of the lens 52. This pre-form shape preferably has a spherical shape, a spheroidal shape, or a meniscus shape close to the shape of a formed lens for example. However, this pre-form shape in this embodiment has a spheroidal shape having a curvature radius smaller than the curvature radii of the concave face 51A of the lens 51 and the formation surface 501A of the lower metal mold 501. The shape as described above provides an easier positioning of the lens material 52′.

Next, the lens 52 is formed by the upper metal mold 503 at the forming temperature Tp₂ as shown in FIG. 22. The forming temperature TP₂ is higher than Tg₂ and is determined by appropriately selecting a temperature close to the deformation point temperature At₂. It is noted that FIG. 22 does not show a metal mold for forming side surfaces of the lens 51 and the lens 52. This not shown metal mold may be integrated with the upper mold 503.

Here, the lens 51 and the lens 52 are fused by a glass-to-glass chemical reaction. Furthermore, the lens 51 itself does not deform because the lens 51 has a higher glass deformation point temperature and a higher glass transition temperature than those of the lens 52 and has a relation of Tg₁>At₂.

After the formation of the lens 52, the lower metal mold 501, the upper metal mold 503, and the lens 52 are cooled to a temperature close to a room temperature to remove the upper metal mold 503. Then, the multifocal lens 5 including the layered structure of the lens 51 and the lens 52 and having the structure in which one group includes two layers is removed from the lower metal mold 501.

Through the respective steps as described above, the multifocal lens 5 having the structure in which one group includes two layers shown in FIGS. 18(A) and 18(B) is manufactured. According to Embodiment 5 as described above, the same effect as that of Embodiment 4 can be provided and an arbitrary number of lenses 51 can be provided at arbitrary positions of the lens 52, thus providing a significantly improved freedom degree in the lens design.

### Embodiment 6

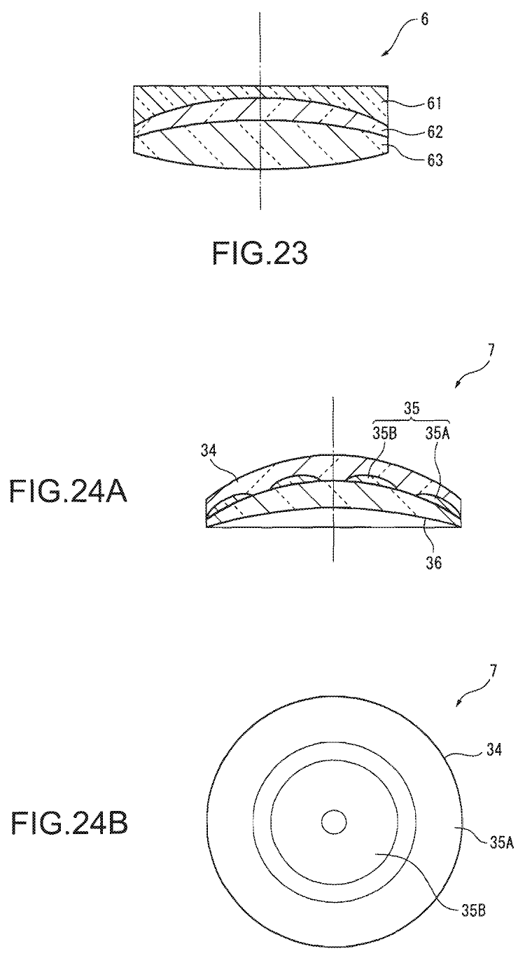

Next, Embodiment 6 of the invention will be described with reference to FIG. 23. Embodiment 6 has the same structure as that of Embodiment 1 except for the shapes of the respective lenses.

FIG. 23 is a schematic cross-sectional view illustrating the structure of a multifocal lens 6 of Embodiment 6 having a structure in which one group includes three layers.

As shown in FIG. 23, the multifocal lens 6 has a structure that is obtained by layering, from the flat surface side at the upper part of FIG. 23, the first lens 61 (hereinafter may be simply referred to as “lens 61”) having the glass deformation point temperature At₁, the second lens 62 (hereinafter may be simply referred to as “lens 62”) having the glass deformation point temperature At₂, and the third lens 63 (hereinafter may be simply referred to as “lens 63”) having the glass deformation point temperature At₃. Here, the above-described glass deformation point temperatures have a relation of At₁>At₂>At₈, Furthermore, the respective lenses have glass transition temperatures for which a relation of Tg₁>Tg₂>Tg₃, a relation of Tg₁>At₂, and a relation of Tg₂>At₃ are established.

As can be seen from FIG. 23, the lens 61, the lens 62, and the lens 63 have an identical outer diameter. Furthermore, these three lenses 61, 62, and 63 have an identical optical axis L.

The first lens 61 is a concave lens and the second lens 62 and the third lens 63 have an outer diameter that is substantially the same as the outer diameter of the first lens 61.

Lens materials (glass material) for forming the respective lenses 61, 62, and 63 used in Embodiment 6 have the same basic specifications as those of the respective lenses 11, 12, and 13 of Embodiment 1 shown in Table 1. Any of the materials is made by OHARA INC. and has an optical lens grade.

A method for manufacturing the multifocal lens 6 as described above can be summarized that the step of forming the lens 11, the step of forming the lens 12, and the step of forming the lens 13 shown in the manufacture method of the multifocal lens 1 of Embodiment 1 are used to form, instead of the lens 11, the lens 12, and the lens 13, the lens 61, the lens 62, and the lens 63, respectively. The method for manufacturing the multifocal lens 6 is the same as that of the method for manufacturing the multifocal lens 1 and will not be described further.

Through the respective steps of Embodiment 1 as described above, the multifocal lens 6 shown in FIG. 6 having the structure in which one group includes three layers is manufactured.

Embodiment 6 can provide the same effect as that by Embodiment 1.

### Embodiment 7

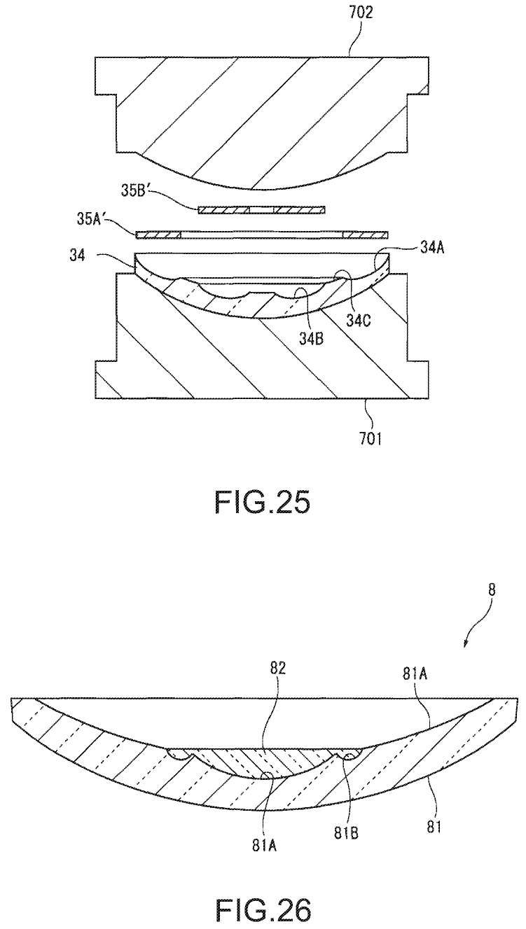

Next, Embodiment 7 of the invention will be described with reference to FIGS. 24(A) and 24(B) and FIG. 25.

Embodiment 7 has the same structure as that of Embodiment 1 except for the structure of an intermediate lens.

FIGS. 24(A) and 24(B) are a schematic cross-sectional view illustrating the structure of a multifocal lens 7 of Embodiment 7 having a structure in which one group includes three layers.

As shown in FIGS. 24(A) and 24(B), the multifocal lens 7 is has a structure that is obtained by layering, from the convex face side, the first lens 34 (hereinafter may be simply referred to as “lens 34”), the second lens 35 (hereinafter may be simply referred to as “lens 35”), and the third lens 36 (hereinafter may be simply referred to as “lens 36”).

As can be seen from FIGS. 24(A) and 24(B), the lens 34, the lens 35, and the lens 36 have an identical outer diameter. The lens 35 is composed of lenses 35A and 35B. The lenses 35A and 35B have a doughnut-like shape having no center part. The lenses 35A and 35B are formed to have a concentric circle-like shape and are arranged to have a space therebetween and to have no contact. Furthermore, these three lenses 34, 35, and 36 have an identical optical axis L.

Lens materials (glass materials) for forming the respective lenses 34, 35, and 36 used in Embodiment 7 have the same basic specifications as those of the respective lenses 11, 12, and 13 of Embodiment 1 shown in Table 1. Any of the materials is made by OHARA INC. and has an optical lens grade.

Hereinafter, a method for manufacturing the multifocal lens 7 as described above will be described with reference to FIG. 25.

(Step of Forming Lens 34)

First, the lens 34 is formed. The lens 34 has a concave face 34C in which a concave section 34A and a concave section 34B are formed. It is noted that a step of forming the lens 34 can be summarized that the step of forming lens 11 shown in Embodiment 1 is used to form, instead of the lens 11, the lens 34. The step of forming the lens 34 is the same as the step of forming the lens 11 and thus will not be further described.

(Step of Forming Lens 35)

After the formation of the lens 34, the lens 34 is cooled to a temperature close to a room temperature and an upper metal mold 702 for forming the lens 35 is placed (FIG. 25).

As shown in FIG. 25, the lens 34 is structured so that the concave face 34C is formed at the upper surface and the outer periphery thereof has a doughnut-like shape concave section 34A and the substantial center part has a concave section 34B. The concave section 34A and the concave section 34B have curvature radii smaller than a curvature radius of the concave face 34C.

Next, a doughnut-like shape lens material 35A′ having no center part is placed on the concave section 34A at the upper surface of the lens 34 and a doughnut-like shape lens material 35B′ having no center part is placed on the upper surface of the concave section 34B. The lens material 35A′ and the lens material 35B′ are manufactured in advance to have the same volume as the design volume of the lens 35.

Then, the upper metal mold 702 is used to form the lens 35 at the forming temperature Tp₂. The forming temperature Tp₂ is higher than Tg₂ and is determined by appropriately selecting a temperature close to the deformation point temperature At₂.

Then, the lens 35 and the lens 34 are fused by a glass-to-glass chemical reaction. The lens 34 itself does not deform because the lens 34 has a higher glass deformation point temperature and a higher glass transition temperature than those of the lens 35 and has a relation of Tg₁>At₂.

(Step of Forming Lens 36)

After the formation of the lens 35, the lens 36 is formed at the forming temperature Tp₃. It is noted that the step of forming the lens 36 can be summarized that the step of forming the lens 13 of Embodiment 1 is used to form, instead of the lens 13, the lens 36. The step of forming the lens 36 is the same as the step of forming the lens 13 and thus will not be described further.

Through the respective steps as described above, the multifocal lens 7 shown in FIGS. 24(A) and 24(B) having the structure in which one group includes three layers is manufactured. Embodiment 7 can provide the same effect as that by Embodiment 1.

### Embodiment 8

Next, Embodiment 8 of the invention will be described with reference to FIG. 26 to FIGS. 29(A), 29(B), and 29(C).

Embodiment 8 has the same structure as that of Embodiment 4 except for the shapes of the respective lenses.

FIG. 26 is a schematic cross-sectional view illustrating the structure of a multifocal lens 8 of Embodiment 8 having the structure in which one group includes two layers.

As shown in FIG. 26, the multifocal lens 8 having the structure in which one group includes two layers has a structure that is obtained by layering, from the convex face side, the first lens 81 (hereinafter may be simply referred to as “lens 81”) having glass deformation point temperature At₁ and the second lens 82 (hereinafter may be simply referred to as “lens 82”) having the glass deformation point temperature At₂. The above-described glass deformation point temperatures have a relation of At₁>At₂. Furthermore, the respective lenses have the glass transition temperatures for which a relation of Tg₁>Tg₂ and a relation of Tg₁>At₂ are established.

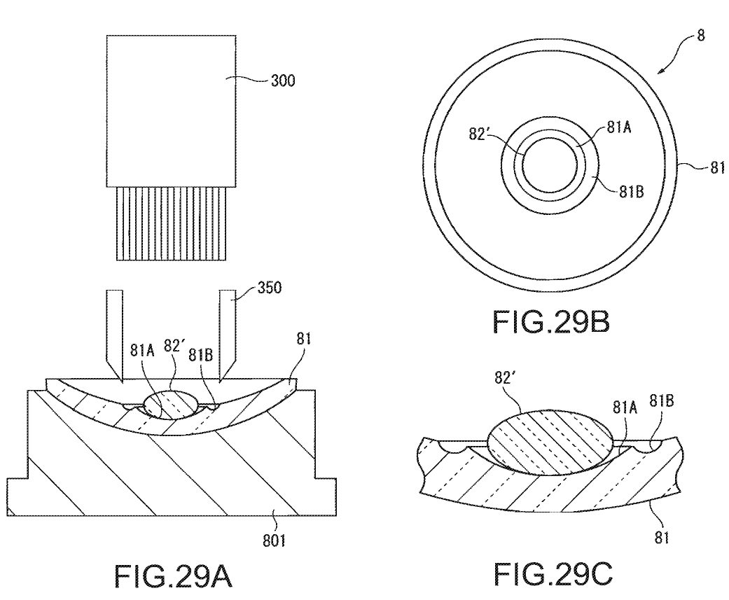

The lens 81 has an outer shape larger than the outer diameter of the lens 82 (see FIGS. 29(A), 29(B), and 29(C)). These two lenses 81 and 82 have an identical optical axis L.

The first lens 81 is structured so that the upper surface of the center part has a concave section 81A and uneven sections 81B that surround the concave section 81A in a circular manner and that are used for a positioning purpose. The second lens 82 includes a protrusion section so as to be engaged with these concave section 81A and uneven section 81B.

Lens materials (glass materials) for forming the respective lenses 81 and 82 of Embodiment 8 have the same basic specifications as the specification shown in Embodiment 4 and thus will not be further described.

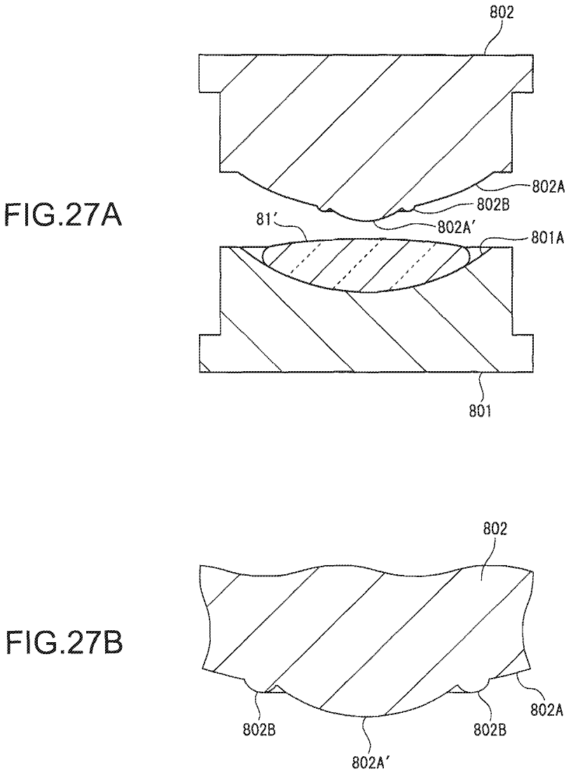

A method for manufacturing the multifocal lens 8 as described above will be described with reference to FIGS. 27(A) and 27(B) to FIGS. 29(A), 29(B), and 29(C).

(Step of Forming Lens 81)

FIG. 27(A) is a schematic status cross-sectional view illustrating lens material 81′ having a higher glass deformation point temperature and a higher glass transition temperature placed on a formation surface 801A of a lower metal mold 801. FIG. 27(B) is a partial expanded cross-sectional view illustrating a partial expanded view of a formation surface 802A of an upper metal mold 802 shown in FIG. 27(A).

The lens material 81′ is manufactured in advance as pre-form glass material having the same volume as the design volume of the lens 81. The lens material 81′ may have a spherical shape, a spheroidal shape, or a meniscus shape close to the shape of a formed lens for example.

Here, the upper metal mold 802 has the formation surface 802A having a downwardly convex shape. At the substantial center part of the formation surface 802A of the upper metal mold 802, a convex section 802A′ is formed at a further lower side. At a part at which the formation surface 802A of the upper metal mold 802 is connected to the convex section 802A′, the uneven section 802B is formed on the concentric circle of the formation surface 802A and the convex section 802A′. It is noted that, instead of forming the uneven section 802B at a further lower side of the formation surface 802A, the uneven section 802B also may be formed at an upper side of the formation surface 802A.

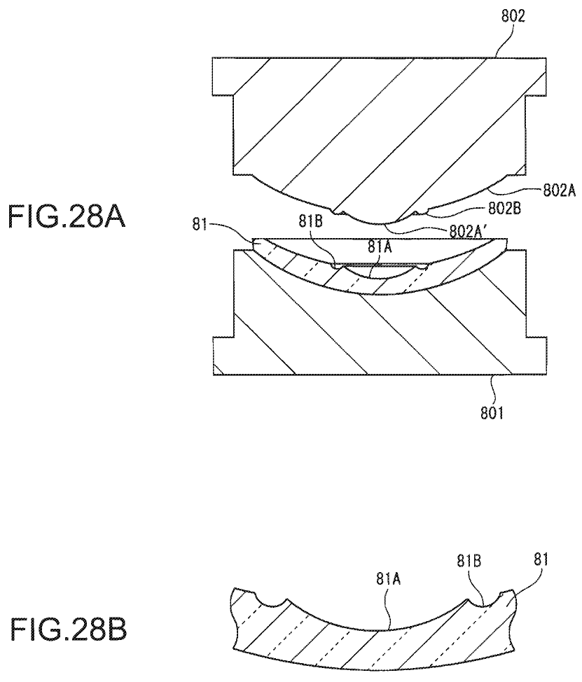

After the placement of the lens material 81′ on the formation surface 801A of the lower metal mold 801, the lower metal mold 801, the upper metal mold 802, and the lens material 81′ are heated to the forming temperature Tp₁ to close the lower metal mold 801 and the upper metal mold 802, thereby forming the lens 81. The forming temperature is higher than Tp₁ and is determined by appropriately selecting a temperature close to the deformation point temperature At₁. When the upper metal mold 802 having been pressed is raised, the lens 81 is left in the lower metal mold 801 as shown in FIGS. 28(A) and 28(B). This lens 81 includes the concave section 81A and the uneven section 811B, respectively.

(Step of Forming Lens 82)

FIGS. 29(A), 29(B), and 29(C) are a schematic status cross-sectional view illustrating a status when the upper metal mold 802 is removed after the formation of the lens 81. FIG. 29(B) is a schematic top view of FIG. 29(A). FIG. 29(C) is a partial expanded cross-sectional view illustrating a partial expanded view of the lens 81 shown in FIG. 29(A).

As shown in FIGS. 29(A), 29(B), and 29(C), the lens material 82′ is placed on the concave section 81A of the lens 81 while using an image processing camera 300 and an adjustment hand 350 placed at an upper part of the lens 81 and the lens material 82′. Specifically, the image processing camera 300 is used to obtain, from the upper part of FIG. 29(A), information for a positional relation between the uneven section 81B for a positioning purpose and the lens material 82 as shown in FIG. 29(B). This positional relation information is used to drive the adjustment hand 350 to position the lens material 82′ at the substantial center of the lens 81.

The lens material 82′ is manufactured in advance as pre-form glass material having the same volume as the design volume of the lens 82. This pre-form shape preferably has a spherical shape, a spheroidal shape, or a meniscus shape close to the shape of a formed lens for example. However, this pre-form shape in this embodiment has a spheroidal shape having a curvature radius smaller than the curvature radius of the concave section 81A of the lens 81. The shape as described above provides an easier positioning of the lens material 82′.

After the positioning of the lens material 82′, the lens 82 is formed at the forming temperature Tp₂. The forming temperature Tp₂ is higher than Tg₂ and is determined by appropriately selecting a temperature close to the deformation point temperature At₂.

Then, the lens 81 and the lens 82 are fused by a glass-to-glass chemical reaction. The lens 81 itself does not deform because the lens 81 has a higher glass deformation point temperature and a higher glass transition temperature than those of the lens 82 and has a relation of Tg₂>At₂.

Through the respective steps as described above, the multifocal lens 8 shown in FIG. 26 having the structure in which one group includes two layers is manufactured. Embodiment 8 can provide, in addition to the effect by Embodiment 4, an effect as described below.

The concave section 81A is provided at the contact surface of the first lens 81. The uneven section 81B for a positioning purpose is formed on the concentric circle of this concave section 81A. The concave section 81A surrounded by the uneven section 81B for a positioning purpose has thereon the second lens material to provide the second lens 82. The second lens 82 is bonded to the first lens 81 simultaneously at the time of forming the second lens 82. Thus, when the second lens material is placed on the first lens 81, the uneven section 81B can be used for a positioning purpose. Thus, the second lens 82 can be accurately positioned to the first lens 81.

### Embodiment 9

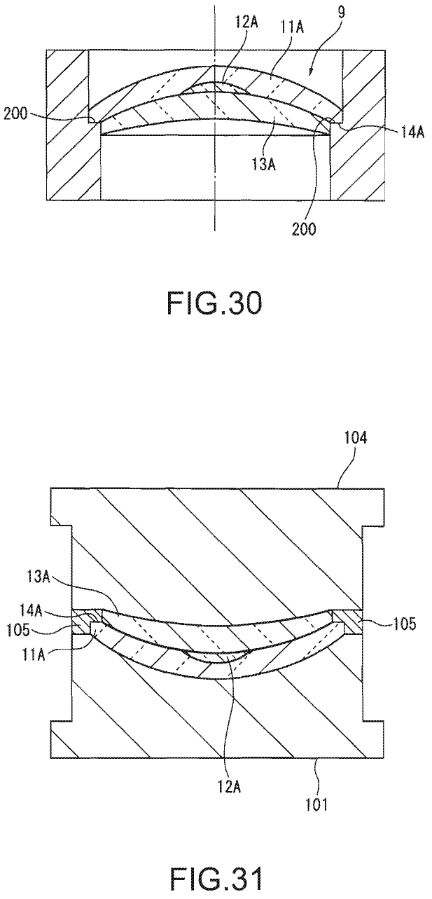

Next, Embodiment 9 of the invention will be described with reference to FIG. 30 to FIGS. 33(A) and 33(B).

Embodiment 9 has the same structure as that of Embodiment 1 except for that a reference surface is provided at an outer periphery of the lens that is attached to a to-be-attached member.

FIG. 30 is a schematic cross-sectional view illustrating a multifocal lens in Embodiment 9 having a structure in which one group includes three layers.

As shown in FIG. 30, the multifocal lens 9 has a structure that is obtained by layering, from the convex face side, the first lens 11A, the second lens 12A, and the third lens 13A.

As can be seen from FIG. 30, the lens 11A and the lens 13A have different outer diameters. This provides a reference surface 14A having at least two different diameters that allows the outer periphery of the multifocal lens 9 to be positioned at a lens to-be-attached portion 200 having a stepped shape. This lens to-be-attached portion 200 is formed as a mirror body.

These three lenses 11A, 12A, and 13A have an identical optical axis L.

Lens materials (glass materials) for forming the respective lenses 11A, 12A, and 13A of Embodiment 9 have the same basic specifications as the specifications of the respective lenses 11, 12, and 13 of Embodiment 1 shown in Table 1. Any of the materials is made by OHARA INC. and has an optical lens grade.

A method for manufacturing the multifocal lens 9 as described above will be described with reference to FIG. 31.

FIG. 31 is a schematic cross-sectional view illustrating a step of forming the lens 13A of the multifocal lens 9. With regards to the step of forming the lens 13A of Embodiment 9, a metal mold that was not described when the step of forming the lens 13 according to Embodiment 1 was described with reference to FIG. 6 will be described.

In the step of forming the lens 13A of Embodiment 9, the lens 13A is formed by the upper metal mold 104 and the lower metal mold 101 with the stepped shaped metal mold 105 being provided between the upper metal mold 104 and the lower metal mold 101. In this manner, the multifocal lens 9 shown in FIG. 30 is manufactured.

It is noted that the step of forming the lens 11A and the step of forming the lens 12A in the method for manufacturing the multifocal lens 9 are the same as the step of forming the lens 11 and the step of forming the lens 12 described for Embodiment 1, and thus will not be described.

Embodiment 9 as described above can provide, in addition to the same effect as that by Embodiment 1, an effect as described below.

The reference surface 14A having two different diameters is provided at the outer periphery of the multifocal lens 9 in order to position the multifocal lens 9 at the lens to-be-attached portion 200 having a stepped shape. Three kinds of lens materials are diluted so that the second lens 12A has a diameter smaller than those of the first lens 11A and the third lens 13A. The first lens 11A and the third lens 13A have an identical optical axis. Thus, by forming the reference surface 14A at the outer periphery of the multifocal lens 9, the multifocal lens 9 can be positioned at the lens to-be-attached portion 200 having a stepped shape to accurately place the multifocal lens 9 at the lens to-be-attached portion 200. This can reduce an inclination or an eccentric core of the multifocal lens 9.

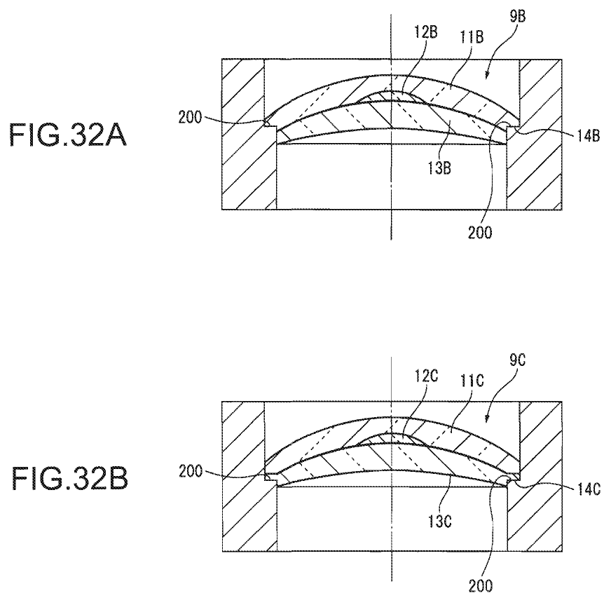

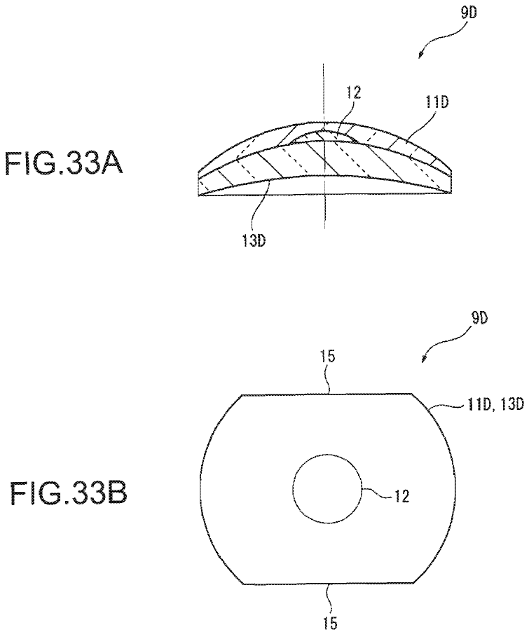

It is noted that Embodiment 9 is not limited to the above-described structure and also includes modifications shown in FIGS. 32(A) and 32(B) and FIGS. 33(A) and 33(B).

FIG. 32(A) is a schematic cross-sectional view illustrating the structure of the multifocal lens 9B having the structure in which one group includes three layers.

As can be seen from FIG. 32(A), the lens 11B and the lens 13B have different outer diameters and the lens 11B have two different outer diameters. This provides the reference surface 14B having at least two different diameters that allows the outer periphery of the multifocal lens 9B to be positioned at the lens to-be-attached portion 200 having a stepped shape. It is noted that these three lenses 11B, 12B, and 13B have an identical optical axis L.

FIG. 32(B) is a schematic cross-sectional view illustrating the structure of the multifocal lens 9C.

As can be seen from FIG. 32(B), the lens 11B and the lens 13B have an identical outer diameter and lens 11B have two different outer diameters. This provides a reference surface 14C having at least two different diameters that allows the outer periphery of the multifocal lens 9C to be positioned at the lens to-be-attached portion 200 having a stepped shape.

FIGS. 33(A) and 33(B) are a schematic cross-sectional view illustrating the structure of a multifocal lens 9D having a structure in which one group includes three layers.

The multifocal lens 9D shown in FIGS. 33(A) and 33(B) can be summarized that, instead of the circular shape of the outer periphery of the multifocal lens 1 of Embodiment 1 shown in FIG. 1, a straight cutoff reference surface 15 is formed that allows the circular-shaped outer periphery to be positioned at a lens to-be-attached portion.

As shown in FIGS. 33(A) and 33(B), the multifocal lens 9D has a structure that is obtained by layering, from the convex face side, the first lens 11D (hereinafter may be simply referred to as “lens 11D”) having the glass deformation point temperature At₁, the second lens 12 (hereinafter may be simply referred to as “lens 12”) having the glass deformation point temperature At₂, and the third lens 13D (hereinafter may be simply referred to as “lens 13D”) having the glass deformation point temperature At₃. The above-described glass deformation point temperatures have a relation of At₁>At₂>At₃. Furthermore, the respective lenses have glass transition temperatures for which a relation of Tg₁>Tg₂>Tg₃, a relation of Tg₁>At₂, and a relation of Tg₂>At₃ are established.

As can be seen from FIGS. 33(A) and 33(B), the lens 11D and the lens 13D have an identical outer diameter. The cutoff reference surface 15 is provided that allows the circular-shaped outer periphery of the multifocal lens 9D to be positioned at a lens to-be-attached portion. In FIGS. 33(A) and 33(B), two cutoff reference surfaces 15 are formed. The two cutoff reference surfaces 15 are formed so as to be substantially parallel to each other. It is noted that, although two cutoff reference surfaces 15 were provided in Embodiment 9, one or more reference surfaces 15 also may be formed. Although the cutoff reference surfaces 15 were formed so as to be substantially parallel to each other in Embodiment 9, the cutoff reference surfaces 15 also may be formed to have a designed angle or also may be contacted to each other.

This provides the reference surface 14A having at least two different diameters that allows the outer periphery of the multifocal lens 9D to be positioned at the lens to-be-attached portion 200 having a stepped shape. Furthermore, these three lens 11D, 12, and 13D have an identical optical axis L.

Lens materials (glass materials) for forming the respective lenses 11D, 12, and 13D of Embodiment 9 have basic specifications as the specifications of the respective lenses 11, 12, and 13 of Embodiment 1 shown in Table 1. Any of the materials is made by OHARA INC. and has an optical lens grade.

A method for manufacturing the multifocal lens 9D as described above is the same as the method of manufacturing the multifocal lens 1 of Embodiment 1 shown in FIG. 2 to FIG. 7 and thus will not be described further.

### Embodiment 10

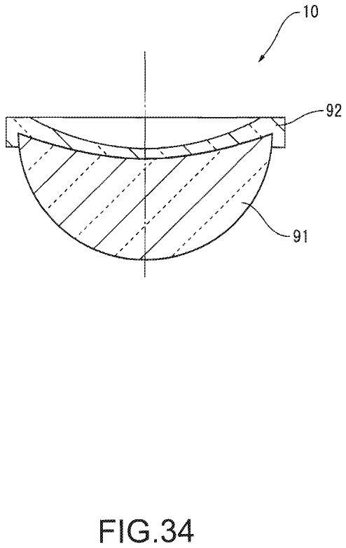

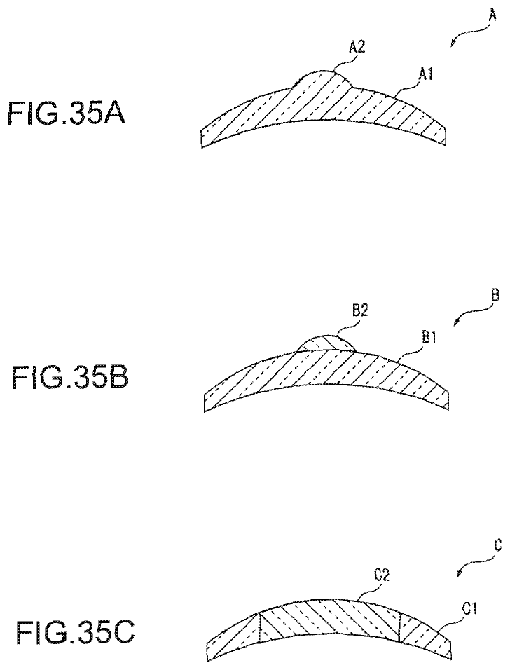

Next, Embodiment 10 of the invention will be described with reference to FIG. 34.

FIG. 34 is a schematic cross-sectional view illustrating the structure of a multifocal lens 10 of Embodiment 10 as a modification of the structure in which one group includes two layers.

The multifocal lens 10 shown in FIG. 34 can be summarized that, while the multifocal lens 4 of Embodiment 4 shown in FIG. 12 is made of synthetic resin, the multifocal lens 10 includes two kinds of lens materials of synthetic resin and glass.

A method for manufacturing the multifocal lens 10 as described above is the same as the method for manufacturing the multifocal lens 4 of Embodiment 4 shown in FIG. 13 to FIG. 17 and thus will not be described further.

Embodiment 10 as described above can provide, in addition to the effect by Embodiment 4, an effect as described below.

Among the two kinds of lens materials, at least one type of lens material is synthetic resin and the other type of lens material is glass. Thus, a multifocal lens composed of glass and synthetic resin is obtained by joining a lens of glass with a formed synthetic resin having a superior formability than that of glass. This can provide a multifocal lens for which a refractive index can be selected in a narrower range and a smaller thermal expansion coefficient is obtained, a superior weather resistance of glass is maintained, and a shape is possible that is obtained by a formability equal to that of synthetic resin and that is difficulty provided if only glass is used.

It is noted that the invention is not limited to the above-described embodiments and the change or modification within the scope within which the objective of the invention can be achieved is included in the invention.

For example, although the above-described embodiments has described a multifocal lens having the structure in which one group includes two layers and a multifocal lens having the structure in which one group includes three layers, a multifocal lens having a structure in which one group includes multiple layers of four layers or more also can be used.

The invention can provide a method of manufacturing a multifocal lens that is favorably applied to a camera lens module using a solid-state image sensing device such as CCD or CMOS for example.

The entire disclosure of Japanese Patent Application Nos: 2006-045787, filed Feb. 22, 2006 and 2007-005024, filed Jan. 12, 2007 are expressly incorporated by reference herein.

What is claimed is:

1. A multifocal lens comprising a group including M layered lenses,
wherein M-kinds (M is an integer of two or more) of lens materials having glass deformation point temperatures of At₁, At₂, . . . , At_{M}, are used and diluted by a heat press method,
wherein a contact surface of an N−1th lens (N is an arbitrary integer of two or more and M or less) contacted with an Nth lens is a concave face, a contact surface of the Nth lens contacted with the N−1th lens is a convex face, and
wherein the glass deformation point temperatures have a relation of At_{N-1}>At_{N}.

2. A method of manufacturing a multifocal lens that includes a group of two layered lenses, comprising
a) forming a first lens by diluting a first lens material having a glass deformation point temperature At₁;
b) forming a second lens by diluting a second lens material having a glass deformation point temperature At₂ (At₁>At₂) while using the first lens as a part of a molding die, and
c) bonding the second lens to the first lens simultaneously with step b) so that a contact surface of the first lens contacting with the second lens is a concave face and a contact surface of the second lens contacting with first lens is a convex face.

3. A method of manufacturing a multifocal lens that includes a group of three layered lenses, comprising:
a) forming a first lens by diluting a first lens material having the glass deformation point temperature At₁ with heat pressing;
b) forming a second lens by diluting a second lens material having a glass deformation point temperature At₂ (At₁>At₂) with heat pressing while using the first lens as a part of a molding die;
c) bonding the second lens to the first lens simultaneously with step b)
d) forming a third lens by diluting a third lens material having a glass deformation point temperature At₃ (At₁>At₂>At₃) with heat pressing while using the first lens and/or the second lens as a part of a molding die; and
e) bonding the third lens to the first lens and/or the second lens simultaneously with step d).

4. The method of manufacturing a multifocal lens according to claim 3, further comprising:
f) forming one or more concave sections at an upper surface of the first lens; and
g) placing the second lens material on the concave sections.

5. The method of manufacturing a multifocal lens according to claim 4, wherein
an upper surface of the first lens other than the concave sections is formed as a concave face;
an upper surface of the second lens is formed to be a curved surface continuous from the concave faces of the first lens; and
the third lens material is placed on an upper surface of the continuous curved surface composed of the concave faces of the first lens and the upper part of the second lens.

6. The method of manufacturing a multifocal lens according to claims 3, wherein step d) further comprises.
d′) forming a reference surface having at least two different diameters so that an outer periphery of the multifocal lens is positioned at a portion having a stepped shape to which the lens is-attached;
d″) making a diameter of the second lens smaller than a diameter of the first lens and a diameter of the third lens; and
d′″) adjusting the optical axis of the third lens to be the same of the optical axis of the first lens.

7. The method of manufacturing a multifocal lens according to claim 3,
wherein the three kinds of lens materials are diluted so that the first lens and the third lens have the almost same diameter and the second lens has a diameter smaller than the diameter of the first lens and,
wherein the optical axis of the third lens is adjusted to be the same of the optical axis of the first lens.

8. The method of manufacturing a multifocal lens according claim 3, wherein the first lens, the second lens, and the third lens are adjusted to have the identical optical axis.

9. The method of manufacturing a multifocal lens according to claim 3, wherein, in the step d), the first lens and the third lens are shaped to have the almost same diameter, the second lens is shaped as a doughnut-like, the second lens is adjusted to have an outer diameter smaller than the diameters of the first lens and the third lens; and the first lens, the second lens, and the third lens are shaped to have an identical optical axis.

10. The method of manufacturing a multi focal lens according to claims 3, wherein
a glass transition temperature of the first lens material is Tg₁, a glass transition temperature of the second lens material is Tg₂, and a glass transition temperature of the third lens is Tg₃;
the respective glass transition temperatures have a relation of Tg₁>Tg₂>Tg₃; and
the respective glass transition temperatures have a relation of Tg₁>At₂ and a relation of Tg₂>At₃.

11. The method of manufacturing a multifocal lens according to claim 2,
wherein, in step a), the first lens material having the glass deformation point temperature At₁ is diluted to provide a concave section of a upper surface at which the first lens is contacted with the second lens and an uneven section for a positioning at a concentric circle of the concave section;
wherein in step b), the second lens material having the glass deformation point temperature At₂ is placed on the concave section surrounded by the uneven section.

12. The method of manufacturing a multifocal lens according to claim 2, further comprising; forming a cutoff reference surface so that an outer periphery of the multifocal lens is positioned at the portion in which the lens is placed.

13. A multifocal lens manufactured by the method of manufacturing a multifocal lens according to claim 2.

14. The multifocal lens according to claim 1, wherein at least one kind of lens material among the M-kinds of lens materials is synthetic resin and at least one another type of lens material is glass.
